(19) United States
(12) Patent Application Publication
(10) Pub. No.: US 2017/0017902 A1
(43) Pub. Date: Jan. 19, 2017

(54) DISTRIBUTED MACHINE LEARNING ANALYTICS FRAMEWORK FOR THE ANALYSIS OF STREAMING DATA SETS FROM A COMPUTER ENVIRONMENT

(71) Applicant: SIOS Technology Corporation, Lexington, SC (US)

(72) Inventors: Sergey A. Razin, Columbia, SC (US); Yokuki To, Columbia, SC (US)

(73) Assignee: SIOS Technology Corporation, Lexington, SC (US)

(21) Appl. No.: 15/210,355

(22) Filed: Jul. 14, 2016

Related U.S. Application Data
(60) Provisional application No. 62/192,548, filed on Jul. 14, 2015.

(51) Int. Cl. G06N 99/00; G06F 9/455

(52) U.S. Cl. CPC G06N 99/005; G06F 9/45533

(57) ABSTRACT

Embodiments of the present innovation relate to a host device that includes a configured to receive a set of data elements from a computer infrastructure, the set of data elements relating to at least one attribute of at least one computer environment resource of the computer infrastructure. The controller is configured to assign each data element of the set of data elements to a data retention location based upon a time statistic identifier associated with each data element of the set of data elements and to compare a training data set and the data elements associated with a selected data retention location to detect a data anomaly associated with the set of data elements. In response to detecting the data anomaly associated with the data elements associated with the selected data retention location, the controller is configured to generate a data anomaly notification.

### RELATED APPLICATIONS

This patent application claims the benefit of U.S. Provisional Application No. 62/192,548, filed on Jul. 14, 2015, entitled, “Distributed Machine Learning Analytics Framework for the Analysis of Streaming Data Sets from a Computer Environment,” the contents and teachings of which are hereby incorporated by reference in their entirety.

### BACKGROUND

Enterprises utilize computer systems having a variety of components. For example, these conventional computer systems can include one or more servers and one or more storage devices interconnected by one or more communication devices, such as switches or routers. The servers can be configured to execute one or more virtual machines (VMs) during operation. Each VM can be configured to execute or run one or more applications or workloads.

In certain cases, the computer infrastructure can generate a large amount of data relating to various aspects of the infrastructure. For example, the computer infrastructure can generate latency data related to the operation of associated VMs, storage devices, and communication devices. In turn the computer infrastructure can provide the data in real time to a host device for storage and/or processing.

### SUMMARY

Conventional host devices used with computer infrastructures can suffer from a variety of deficiencies. For example, as provided above, the host device is configured to receive real time data from a computer infrastructure and to store and/or process the data. However, enterprises typically generate large amounts of data over a period of time. With the receipt of the data in real time, the host device retains the data in a central storage location, which can be difficult to manage as the data set grows over time.

Further, transformation and processing of the data is typically very restricted, inflexible, and, in many cases, hard coded into the host device. Accordingly, any changes to the processing requires a substantial investment in time and engineering to address different transformation (e.g., use) cases.

By contrast to conventional computer infrastructure data management techniques, embodiments of the present innovation relate to a distributed machine learning analytics framework for the analysis of streaming data sets from a computer environment. Embodiments of the present innovation relate to a distributed machine learning analytics framework for the analysis of streaming data sets from a computer environment. In one arrangement, a host device executes a machine learning engine which is configured to automate the movement and analysis of data elements received from a computer or enterprise system over time. For example, the machine learning engine can include a data retention function which is configured to ingest, categorize, and store large numeric data sets associated with the computer environment. The data retention function is also configured to address the reduced precision of aging data elements by identifying and re-categorizing aging data elements maintained by the host device. In another example, the machine learning engine is also configured to transform and analyze data elements, as retained by the host device in retention locations, relative to a training data set to identify anomalous activity associated with the computer infrastructure on a substantially ongoing basis.

In one arrangement, the host device is configured to develop the training data set based on the retained data set. For example, the host device is configured to access a selected retention location and to classify or cluster the data elements from the selected retention location to develop the training data set. Accordingly, the training data set defines learned behavioral patterns of particular data sets. In use, the host device is configured to compare the learned behavioral pattern of the training data set to data elements retrieved from the retention locations to detect anomalous data elements, indicative of anomalous behavior in the computer infrastructure.

With such a configuration, the machine learning engine of the host device can be readily configured to adopt the machine leaning analytics functionality to different algorithms, tools, and framework as well as to the requirements of data element distribution and parallel analysis on an as-needed basis. For example, the distributed configuration of the machine learning engine of the host device provides a systems administrator with the ability to adjust the functionalities of the machine learning engine independent from each other.

In one arrangement, embodiments of the innovation relate to, in a host device, a method for analyzing a set of data elements from a computer infrastructure. The method includes receiving, by the host device, the set of data elements from the computer infrastructure, the set of data elements relating to at least one attribute of at least one computer environment resource of the computer infrastructure. The method includes assigning, by the host device, each data element of the set of data elements to a data retention location based upon a time statistic identifier associated with each data element of the set of data elements. The method includes comparing, by the host device, a training data set and the data elements associated with a selected data retention location to detect a data anomaly associated with the set of data elements. The method includes, in response to detecting the data anomaly associated with the data elements associated with the selected data retention location, generating, by the host device, a data anomaly notification.

In one arrangement, embodiments of the innovation relate to a host device comprising a controller having a memory and a processor, the controller configured to receive a set of data elements from a computer infrastructure, the set of data elements relating to at least one attribute of at least one computer environment resource of the computer infrastructure and assign each data element of the set of data elements to a data retention location based upon a time statistic identifier associated with each data element of the set of data elements. The controller is configured to compare a training data set and the data elements associated with a selected data retention location to detect a data anomaly associated with the set of data elements and, in response to detecting the data anomaly associated with the data elements associated with the selected data retention location, generate a data anomaly notification.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a schematic representation of a computer system, according to one arrangement.

FIG. 2 is a flowchart of an example procedure performed by the host device of FIG. 1, configured according to one arrangement.

FIG. 3 illustrates a schematic representation of a host device of FIG. 1 processing data elements from a computer infrastructure, according to one arrangement.

FIG. 4 illustrates an arrangement of the host device of FIG. 2 executing a retention function, according to one arrangement.

FIG. 5 illustrates an arrangement of the host device of FIG. 2 executing a training function and an analysis function, according to one arrangement.

FIG. 6 illustrates application of a classification function to a set of data elements, according to one arrangement.

### DETAILED DESCRIPTION

Embodiments of the present innovation relate to a distributed machine learning analytics framework for the analysis of streaming data sets from a computer environment. In one arrangement, a host device executes a machine learning engine which is configured to automate the movement and analysis of data elements received from a computer or enterprise system over time. For example, the machine learning engine can include a data retention function which is configured to ingest and categorize large numeric data sets associated with the computer environment. The data retention function is also configured to address the reduced precision of aging data elements by identifying and re-categorizing aging data elements maintained by the host device. In another example, the machine learning engine is also configured to transform and analyze subsets of the data elements relative to a training data set to identify anomalous activity associated with the infrastructure on a substantially ongoing basis.

With such a configuration, the machine learning engine of the host device can be readily configured to adopt the machine leaning analytics functionality to different algorithms, tools, and framework, as well as to the requirements of data element distribution and parallel analysis on an as-needed basis. For example, the distributed configuration of the machine learning engine of the host device provides a systems administrator with the ability to adjust the functionalities of the machine learning engine independent from each other.

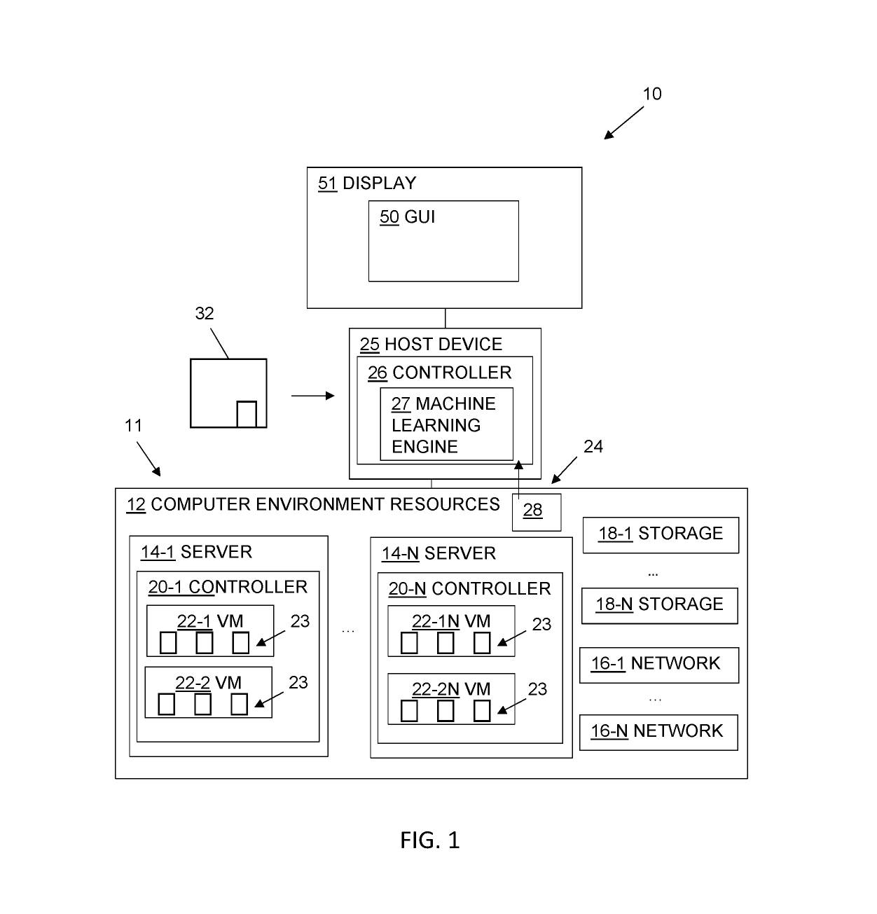

FIG. 1 illustrates an arrangement of a computer system 10 which includes at least one computer infrastructure 11 disposed in electrical communication with a host device 25. While the computer infrastructure 11 can be configured in a variety of ways, in one arrangement, the computer infrastructure 11 includes computer environment resources 12. For example, the computer environment resources 12 can include one or more server devices 14, such as computerized devices, one or more network communication devices 16, such as switches or routers, and one or more storage devices 18, such as disk drives or flash drives.

Each server device 14 can include a controller or compute hardware 20, such as a memory and processor. For example, server device 14-1 includes controller 20-1 while server device 14-N includes controller 20-N. Each controller 20 can be configured to execute one or more virtual machines 22 with each virtual machine (VM) 22 being further configured to execute or run one or more applications or workloads 23. For example, controller 20-1 can execute a first virtual machine 22-1 and a second virtual machine 22-2, each of which, in turn, is configured to execute one or more workloads 23. Each compute hardware element 20, storage device element 18, network communication device element 16, and application 23 relates to an attribute of the computer infrastructure 11.

In one arrangement, the host device 25 is configured as a computerized device having a controller 26, such as a memory and a processor. The host device 25 is disposed in electrical communication with the computer infrastructure 11 and with a display 51. The host device 25 is configured to receive, via a communications port (not shown), a set of data elements 24 from at least one computer environment resources 12 of the computer infrastructure 11 where each data element 28 of the set of data elements 24 relates to an attribute of the computer environment resources 12. For example, the data elements 28 can relate to the compute level (compute attributes), the network level (network attributes), the storage level (storage attributes) and/or the application or workload level (application attributes) of the computer environment resources 12. Also, in one arrangement, each data element 28 can include additional information relating to the computer infrastructure 11, such as events, statistics, and the configuration of the computer infrastructure 11. As a result, the host device 25 can receive data elements 28 that relate to the controller configuration and utilization of the servers devices 14 (i.e., compute attribute), the virtual machine activity in each of the server devices 14 (i.e., application attribute) and the current state and historical data associated with the computer infrastructure 11.

Each data element 28 of the set of data elements 24 can be configured in a variety of ways. In one arrangement, each data element 28 includes object data and statistical data. The object data can identify the related attribute of the originating computer environment resource 12. For example, the object data can identify the data element 28 as being associated with a compute attribute, storage attribute, network attribute or application attribute of a corresponding computer environment resource 12. The statistical data can specify a behavior associated with the at least one computer environment resource.

The host device 25 is further configured with a distributed machine learning analytics framework or engine 27 configured to receive data elements 28 from the computer infrastructure 11, such as via a stream, and to automate movement and analysis of the data elements 28 during operation. For example, as will be described below, when executing the machine learning engine 27, the host device 25 is configured to transform, store, and analyze the data elements 28 over time. Based upon the receipt of the of data elements 28, the host device 25 can provide continuous analysis of the computer infrastructure 11 in order to identify anomalies within the system 10 on a substantially continuous basis.

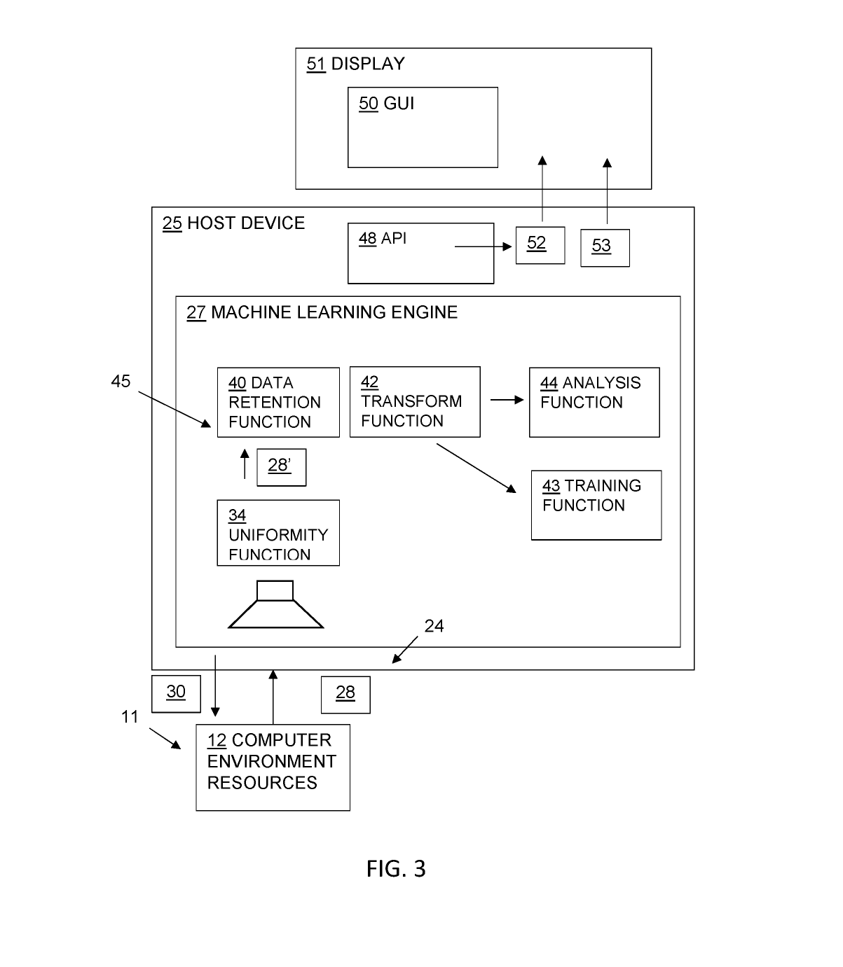

In one arrangement, the machine learning engine 27 includes several functionalities configured in a distributed manner. For example, as will be described in detail below and with reference to FIG. 3, the machine learning engine 27 includes a uniformity function 34, a data retention function 40, a transformation function 42, a training function 43, and an analysis function 44. With such a distributed configuration, the various functionalities of the machine learning engine 27 can be readily adapted by a systems administrator to utilize different algorithms, tools, and framework components.

Returning to FIG. 1, the controller 26 of the host device 25 can store an application for the machine learning analytics framework. For example, the machine learning analytics application installs on the controller 26 from a computer program product 32. In some arrangements, the computer program product 32 is available in a standard off-the-shelf form such as a shrink wrap package (e.g., CD-ROMs, diskettes, tapes, etc.). In other arrangements, the computer program product 32 is available in a different form, such downloadable online media. When performed on the controller 26 of the host device 25, the machine learning analytics application causes the host device 25 to automate the movement and analysis of data elements 28 received from the computer infrastructure 11 over time.

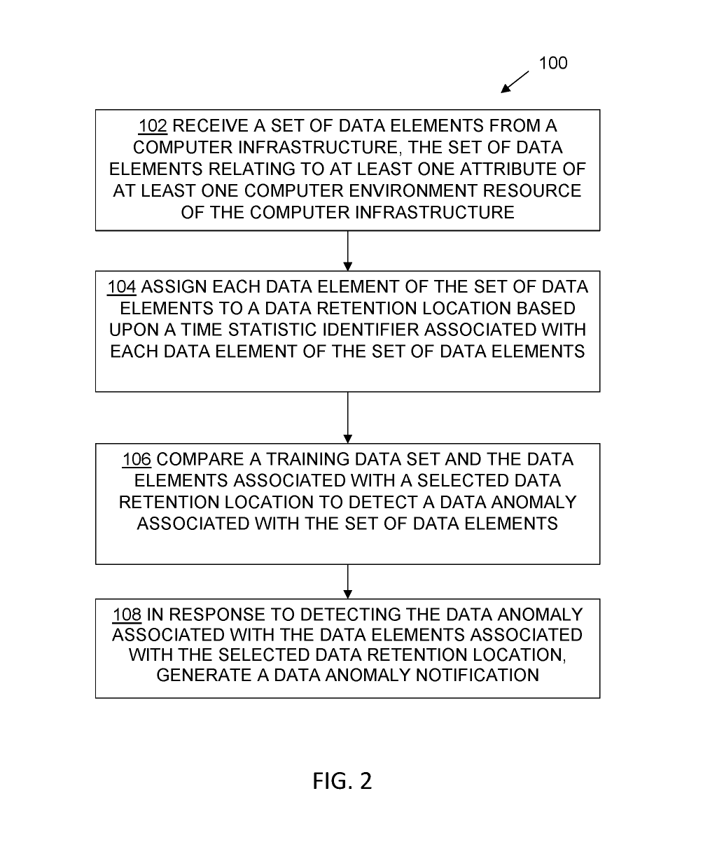

FIG. 2 illustrates a flowchart 100 showing an example method performed by the host device 25 of FIG. 1 when executing the machine learning analytics application 27.

As provided in process element 102 of FIG. 2, the host device 25 is configured to receive a set of data elements 24 from the computer infrastructure 11 where each data element 28 of the set of data elements 24 relates to at least one attribute of at least one computer environment resource 12 of the computer infrastructure 11. For example, with reference to FIG. 3, during operation the host device 25 is configured to request data from the computer environment resources 12, such as via public application program interface (API) calls 30, to receive data elements 28 relating to the compute, storage, and network attributes of the computer infrastructure 11. As provided above, the host device 25 can receive data elements 28 that relate to the controller configuration and utilization of the servers devices 12 (i.e., compute attribute), the virtual machine activity in each of the server devices 14 (i.e., application attribute), or to the current state and historical data associated with the computer infrastructure 11.

While the host device 25 can receive the data elements 28 from the computer infrastructure 11 in a variety of ways, in one arrangement, the host device 25 is configured to receive the data elements 28 as part of a substantially real-time stream. As will be described below, by receiving the data elements 28 as a substantially real-time stream, the host device 25 can monitor activity of the computer infrastructure 11 on a substantially ongoing basis. This allows the host device 25 to detect anomalous activity associated with one or more computer environment resources 12 in response to changes within the computer infrastructure 11 on a substantially ongoing basis over time.

In one arrangement, and with continued reference to FIG. 3, the host device 25 is configured to direct the data elements 28 to the machine learning engine 27 for analysis using one or more engine functions 45. For example, as provided above, the machine learning engine 27 can be configured with a number of engine functions 45 to process the data elements 28 in a variety of ways. The following provides a description of various examples of the engine functions 45.

In one arrangement, in response to receiving the set of data elements 24 from the computer infrastructure 11, the host device 25 is configured to generate a set of normalized data elements 28′ for further processing. For example, the host device 25 can be configured to apply a uniformity function 34 to the set of data elements 24 to generate the set of normalized data elements 28′ having an adjusted format. In use, any number of the computer environment resources 12 can provide the data elements 28 to the host device 25 in a proprietary format (e.g., in a format that is unique to the particular resource 12 itself). In such a case, the host device 25 is configured to apply the uniformity function 34 to the data elements 28 such that the data elements 28 are provided for later processing in a normalized or non-proprietary format.

For example, assume the case where the host device 25 receives data elements 28 from multiple network devices 16 of the computer infrastructure 11 where the data elements 28 identify the input/output (TO) speeds of each network device 16. Further assume that the data elements 28 identify the IO speeds in either seconds (s) or milliseconds (ms). In such a case, the machine learning engine 27 of the host device 25 is configured to apply the uniformity function 34 to format the data elements 28 to a consistent, normalized speed (e.g., ms). In another example, as the host device 25 receives data elements 28 over time, the data elements 28 can include information regarding each of the storage devices 18 or network devices 16 which includes a relatively large amount of variability. In such a case, the machine learning engine 27 of the host device 25 is configured to apply the uniformity function 34 to the data elements 28 to generate an average value associated with the data elements.

As provide above, in one arrangement, the computer infrastructure 11 is configured to provide the data elements 28 to the host device 25 as a stream in substantially real-time. In order to analyze the data elements 25 based upon a particular time of receipt, the host device 25 is configured to organize the data elements 28 based upon age. For example, returning to the flowchart 100 illustrated in FIG. 2, in process element 104, when executing the machine learning analytics application 27, the host device 25 is configured to assign each data element 28 of the set of data elements 24 to a data retention location 60 based upon a time statistic identifier 55 associated with each data element 28 of the set of data elements 24.

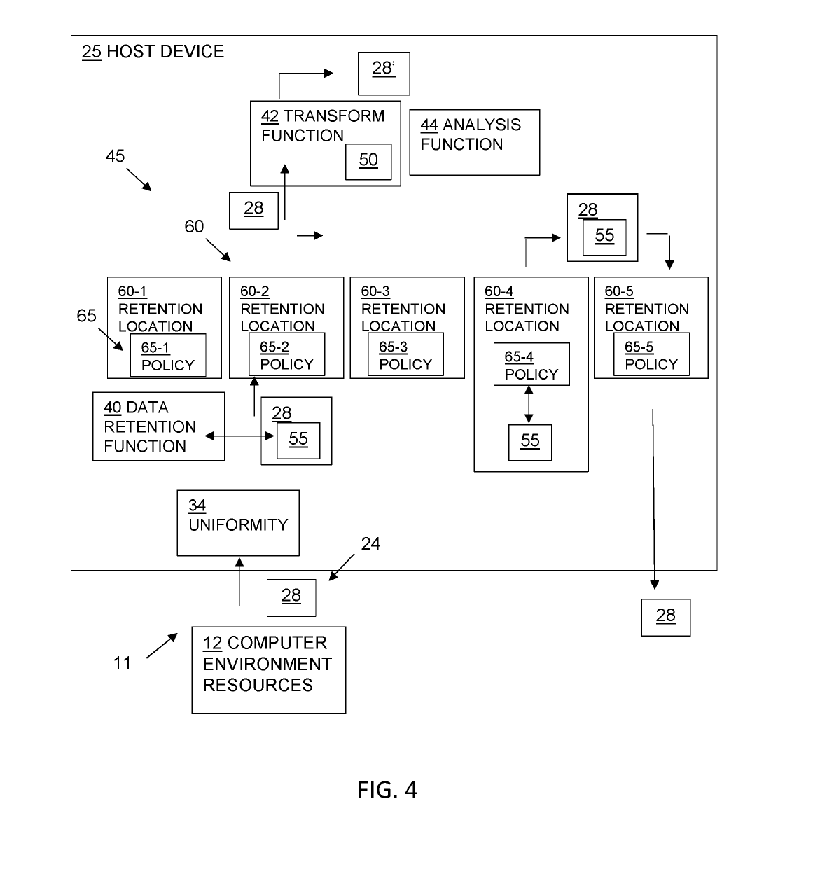

With reference to FIG. 4, to organize the data elements based upon age, the host device 25 is configured to apply a data retention function 40 (i.e., a horizontal roll-up function) to the data elements 28. As described below, the data retention function 40 configures the host device 25 to separate and store the data elements 28 among a set of data retention locations 60 according to the time statistic identifier 55 associated with each data element 28. While the time statistic identifier 55 can be configured in a variety of ways, in one arrangement, the time statistic identifier 55 indicates an age of the data element 28 relative to a time that the host device 25 received the data element 28.

For example, as illustrated in FIG. 4, the host device 25 can be configured with a first retention location 60-1 which stores data elements 28 having a real-time time statistic identifier 55 (e.g., a data element having an age up to 20 seconds from receipt). The host device 25 can be configured with a second retention location 60-2 which stores data elements 28 having a daily-time time statistic identifier 55 (e.g., a data element having an age between 20 seconds and one day from receipt). The host device 25 can also be configured with a third retention location 60-3 which stores data elements 28 having a weekly-time time statistic identifier (e.g., a data element having an age between one day and one week from receipt). The host device 25 can further be configured with a fourth retention location 60-4 which stores data elements 28 having a monthly-time time statistic identifier 55 (e.g., a data element having an age between one week and one month from receipt). Also, the host device 25 can be configured with a fifth retention location 60-5 which stores data elements 28 having a yearly-time time statistic identifier 55 (e.g., a data element having an age between one month and one year from receipt).

During operation, when executing the data retention function 40, as the host device 25 receives data elements 28 from the computer infrastructure 11, the host device 25 is configured to review the time statistic identifier 55 associated with each data element 28 and to assign the data element 28 to a particular retention location 60 based upon the time statistic identifier 55. For example, as the host device 25 receives the data elements 28 from the computer infrastructure 11 as a stream, the host device 25 reviews the time statistic identifier 55 associated with each data element 28 to identify the data elements 28 as a real-time data element (e.g., having an age less than twenty seconds from receipt) and assigns the data element 28 to the first retention location 60-1.

Additionally, when executing the data retention function 40, the host device 25 is configured retain the data elements 28 in each retention location 60 for a given period of time corresponding to a retention policy 65.

With continued reference to FIG. 4, during operation, the data retention function 40 also configures the host device 25 to review each retention location 60 for aging data elements 28 (e.g., data elements 28 having a reduced precision) in order to reassign the data elements 28 to subsequent reduced-precision retention locations 60. For example, for a given retention location 60, the data retention function 40 configures host device 25 to compare the time statistic identifier 55 associated with each data element 28 with a retention policy 65 associated with the data retention location 60. In the case when the time statistic identifier 55 of a given data element 28 of the data retention location 60 meets the retention policy 65 (e.g., is equal to or greater than a term set by the retention policy 65), the host device 25 is configured to assign the data element 28 to a second data retention location 60 having a second retention policy 65 where the second retention policy 65 defines a retention time which is greater than a retention time defined by the previous retention policy 65.

For example, assume the fourth data retention location 60-4 included a retention policy 65-4 which indicates that the data retention location 60-4 is configured to store data elements 28 having an age between one week and one month from receipt. In the case where the host device 25 reviews the data elements 28 in the fourth data retention location 60-4, the data retention function 40 configures the host device 25 to identify data elements having time statistic identifiers 55 which identify the data elements 28 as having an age greater than one month from receipt. In the case where the host device 25 detects one or more data elements 28 with such criteria, the host device 25 is configured to advance the data elements 28 to the fifth retention location 60-5, as directed by the data retention function 40.

With such a configuration of the data retention function 40, the host device 25 can retain large numeric data sets 24 for the objects associated with the computer environment 11. Additionally, execution of the data retention function 40 allows ready analysis of the data elements 28 based upon the age of the data elements 28. That is, the data retention function 40 provides for the analysis of real-time data elements 28 by addressing the overall precision (i.e., relative aging) of the data elements 28 collected by the host device 25. For example, the data retention function 40 configures the host device 25 to separate the data elements 28 based upon hourly, weekly, or monthly time statistics. Accordingly, the host device 25 can be later configured to retrieve particular data elements 28, such as data elements relating to CPU usage, from a particular data retention location, such as daily retention location 60-2, to analyze particular trends, such as an analysis of CPU usage on a daily basis.

The data retention function 40 can also configure the host device 25 to remove aging data elements 28 from the data retention location 60. For example, when executing the data retention function 40, the host device 25 is configured to review the last retention location in the set (in this example, the fifth retention location 60-5) to which stores data elements 28 having the least amount of precision (e.g., a yearly-time time statistic identifier). When the host device 25 detects a data element 28 having a time statistic identifiers 55 that is greater than a precision level configuration or policy level 65-5 of the data retention location 60-5 (e.g., is older than one year from receipt), the host device 25 is configured to remove the data element 28 from the retention location 60-5.

With reference to FIG. 4, in one arrangement, the host device 25 is also configured to provide a transformation function 42 to the data elements 28 associated with the data retention locations 60. As shown, prior to application of an analysis function 44, the host device 25 can apply the transformation function 42 to a set of data elements 24 associated with a particular data retention location 60 to generate a transformed set of data elements 28′.

In one arrangement, the transformation function 42 is configured to manipulate the data elements 28 associated with a computer environment resource 12 according to a transformation policy 50. For example, assume the case where the data retention locations 60 store data elements 28 which identify an amount of storage utilized by the storage devices 18 of the computer environment resources 12. Further assume that the host device 25 is configured to perform an analysis on the monthly cost associated with the storage devices 18 of the computer environment resources 12. Based upon this configuration, the transformation function 42 retrieves the data elements 28 related to the amount of storage utilized by the storage devices 18 from the fourth data retention location 60-4 (i.e., the data retention location 60-4 which stores data elements 28 having a monthly-time time statistic identifier 55). Further, the transformation policy 50, multiplies the each data element 28 by a cost. The resulting transformed set of data 28′ relates to the monthly cost associated with the storage devices 18. As a result, in the case where the host device 25 utilizes the transformation function 42, the host device 25 is configured to apply the analysis function 44 to the transformed set of data 28′ associated with the selected data retention location 60.

In one arrangement, the transformation function 42 is configured to select data elements 28 from a particular data retention location 60 and provide transformed data elements 28′ to the subsequent analysis function 44 and/or to the training function 43 based upon the type of analysis needed and/or the required state of the data elements 28. For example, assume the case where the host device 25 is configured to review CPU utilization of the controllers 20 of the computer infrastructure 11 (i.e., the required state of the host device 25). In such a case, the data elements 28 representing CPU utilization in the first data retention location 60-1 (e.g., the storage location for substantially real-time data elements 28) can have a relatively large amount of variance. Accordingly, the transformation function 42 is configured to detect the required state of the host device 25 (e.g., review CPU utilization of the controllers 20 of the computer infrastructure 11) and to the select an appropriate data retention location 60 based upon the required sate. For example, in the present case, the transformation function 42 can select a data retention location 60 that can provide data elements 28 having a reduced amount of variance, such as data retention location 60-2 which stores data elements 28 having an age between 20 seconds and one day from receipt. Following the selection, the transformation function 42 is configured to provide the selected and transformed data elements 28 to the analysis function 44 for further processing.

Returning to the flowchart 100 illustrated in FIG. 2, in process element 106, when executing the machine learning analytics application 27, the host device 25 is configured to compare a training data set 47 and the data elements 28 associated with a selected data retention location 60 to detect a data anomaly 70 associated with the set of data elements 28. In one arrangement, the host device 25 is configured to apply an analysis function 44 to the training data set 47 and to the data elements 28 to make such a comparison. As provided above, host device 25 can be configured to provide the analysis function 44 to the transformed data elements 28′ from the transformation function 42. However, as an example, a description of the application of the analysis function 44 to the data elements 28 from selected retention location 60 is provided below. Further, as will be described below, the application of the analysis function 44 to both the training data set 47 and the data elements 28 allows the host device 25 to detect the presence of anomalous behavior with respect to the various computer environment resources 12 of the computer infrastructure 11.

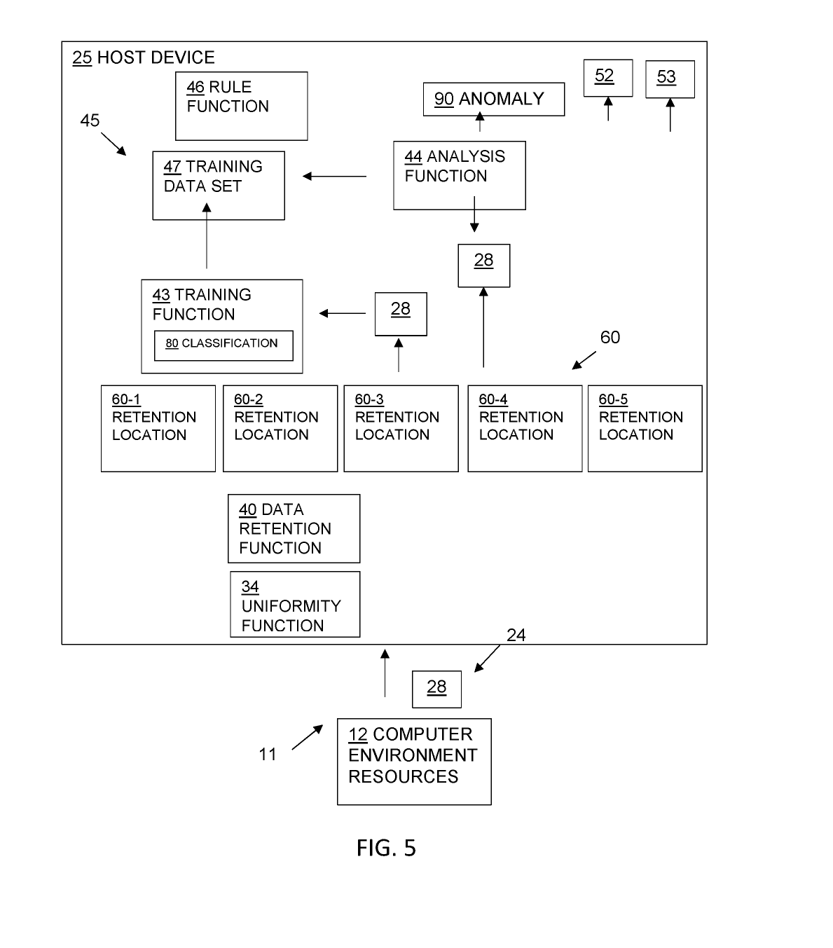

With reference to FIG. 5, prior to application of the analysis function 44, the host device 25 is configured to develop the training data set 47, such as by using the training function 43. The training data set 47 is configured as a baseline set of data (i.e., learned behavior set of data) which identifies particular patterns or trends of behavior of the computer environment resources 12. In one arrangement, with execution of the training function 43, the host device 25 is configured to access a set of data elements 28 from a selected data retention location 60 to develop the training data set 47. For example, to develop the training data set 47 related to weekly CPU utilization of the computer infrastructure 11, the host device 25 can retrieve data elements 28 associated with CPU utilization from the weekly retention location 60-3 and store the data elements 28 as the training data set 47.

In response to retrieving data elements 28 from the particular or selected retention location 60, when executing the training function 43, host device 25 is configured to apply a classification function 80 to the data elements 28 from the selected data retention location 60 to define the training data set 47.

While the classification function 80 can be configured in a variety of ways, in one arrangement, the classification function 80 is configured as a semi-supervised machine learning function, such as a clustering function. Clustering is the task of grouping a set of objects in such a way that objects in the same group, called a cluster, are more similar to each other than to the objects in other groups or clusters. Clustering is a conventional technique for statistical data analysis, used in many fields, including machine learning, pattern recognition, image analysis, information retrieval, and bioinformatics. The grouping of objects into clusters can be achieved by various algorithms that differ significantly in their notion of what constitutes a cluster and how to efficiently find them. For example, known clustering algorithms include hierarchical clustering, centroid-based clustering (i.e., K-Means Clustering), distribution based clustering, and density based clustering. Based upon the clustering, the host device 25 is configured to detect anomalies or degradation in performance as associated with the various components of the computer infrastructure 11.

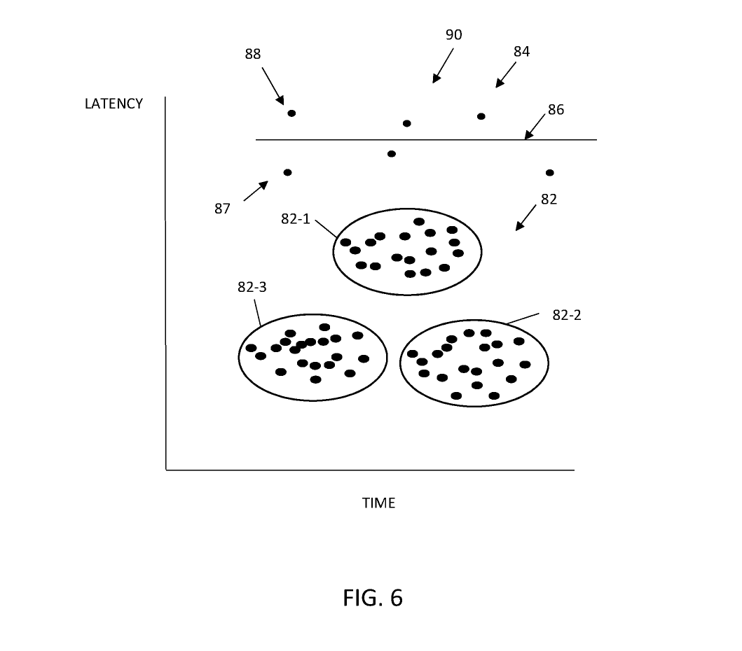

FIG. 6 illustrates an example of the application of the clustering function 80 to the data elements 28 from a selected data retention location 60 to generate the training data set 47. In one arrangement, application of the classification (i.e., clustering) function 80 to the data elements 28 can result in the generation of sets of clusters 82. For example, following application of the characterization function 80, the training data set 47 can include first, second and third clusters 82-1, 82-2, and 82-3, where each cluster 82-1 through 82-3 identifies computer infrastructure attributes having some common similarity.

In one arrangement, the host device 25 is configured to develop the training data set 47 in a substantially continuous and ongoing manner by receiving data elements 28 from a selected data retention location 60 over time. For example, with reference to FIG. 5, to develop the training data set 47 for a particular attribute of the computer infrastructure 11 (e.g., CPU utilization), the host device 25 can be configured to access a substantially real time stream of data elements 28 from a given data retention location 60 (e.g., the first data retention location 60-1, which relates to CPU utilization), over a period of time. The host device 25 is configured to apply the training function 43 to the data elements 28 to continuously develop and train the training data set 47 based upon the ongoing stream of data elements 28. Accordingly, as the computer infrastructure attribute values change over time (e.g., shows an increase or decrease in CPU utilization for particular controllers of the computer infrastructure 11) the training data set 47 can change over time, as well.

As provided above, and with continued reference to FIG. 5, the host device 25 is configured to compare the data elements 28 from a given data retention location 60, such as provided by the transformation function 42 to the training data set 47, such as via application of the analysis function 44. With such application of the analysis function 44, the host device 25 can determine trends associated with the data elements 28 as well as the presence of anomalous behavior associated with the computer environment resources 11.

For example, assume the host device 25 is configured to detect real-time CPU utilization deviation within the computer infrastructure 11. In such a case, the host device 25 can retrieve data elements 28 associated with CPU utilization from a previous week from the weekly data retention location 60-3 as the training data set 47. The host device 25 can also receive data elements 28 representing real-time CPU utilization from a selected data retention location, such as the real-time data retention location 60-1, such as provided by the transform function 42.

With execution of the analysis function 44, by comparing the data elements 28 from the retention location 60 with the training data set 46, the host device 25 is configured to identify outlying data elements 84 as data anomalies which represent anomalous activity associated with the computer infrastructure 11. For example, with reference to FIG. 6, comparison of the data elements 28 from the retention location 60 with the training data set 47 yields a number of data elements 28 which fall outside of the clusters 82. As a result of the analysis (e.g., application of the analysis function), the host device 25 can identify the outlying data elements 84 as anomalous data elements 90 which indicate anomalous behavior (e.g., latency) associated with the computer infrastructure 11.

In one arrangement, and with reference to FIG. 5, to limit the number of outlying elements 84 and to provide a view into the best practices associated with the data elements 28, the host device 25 is also configured to apply a rule function 46 to training data set 47 and to the data elements 28 from a selected data retention location 60. The rule function 46 is configured to define a subset of data elements 28 to be used to identifying a potential anomaly in the operation of the computer infrastructure.

For example, with reference to FIG. 6, assume the rule function 46 is configured to identify outlying data elements 84 that have a CPU utilization that is less than 90%. Application of the rule function 86 divides the outlying elements 84 into a first subset 87 having a CPU utilization that is less than 90% and a second subset 88 having greater than 90% CPU utilization (e.g., indicating bad or erroneous data elements). As a result of the application of the rule function 46, the host device 25 can identify the data element of the first subset 87 as the anomalous data elements 90, which belongs neither to the sets of clusters 82 nor to the second data subset 88.

Returning to the flowchart 100 illustrated in FIG. 2, in process element 106, when executing the machine learning analytics application 27, in response to detecting the data anomaly 90 associated with the data elements 28 associated with the selected data retention location 60, the host device is configured to generate a data anomaly notification 52.

As indicated in FIG. 5, and with additional reference to FIG. 3, following the application of the analysis function 44 to the data elements 28 and the detection of a data anomaly 90, the host device 25 is configured to output a data anomaly notification 52 regarding via an application program interface (API) 48 to the display 51. In one arrangement, the host device 25 is configured to display the data anomaly notification 52 as part of a graphical user interface (GUI) 50 on the display 51. The data anomaly notification 52 provides notification to an end user regarding the anomalous operation of various aspects of the computer infrastructure 11 (e.g., latency for a day, latency over a period of a month, etc.).

In one arrangement, in response to detecting anomalous behavior in the computer infrastructure, the host device 25 can provide one or more infrastructure notifications 53 to the end user via the GUI 50. For example, the host device 25 can provide, as the infrastructure notification 53, analytics, forecasting, and recommendation notifications to the end user via the API 48, based upon the detected anomaly 90.

With the engine functions 45 configured as separate modules (e.g., uniformity function 34, data retention function 40, transformation function 42, training function 43, analysis function 44, and rule function 46), an administrator can update the host device 25 with a variety of separate and different engine functions 45, depending upon the type of processing required.

Accordingly, any changes to the processing requires a minimal investment in time and engineering to address different transformation (e.g., use) cases. Further, employment of the engine functions 45 allows the host device 25 to adopt its analytics framework to different algorithms, tools, framework as well as requirements of distribution and parallel analysis.

Further, based upon the analysis of the stream of data elements 28 and based upon the division of the data elements into data retention location subsets, the host device 25 is configured to provide substantially continuous analysis of the computer environment resources in order to continuously identify anomalies in the infrastructure 11 over time.

Additionally, by analyzing the data elements 28 from the infrastructure for anomalies on an ongoing basis, the host device 25 is configured to improve operation of the computer infrastructure 11. For example, by monitoring and learning from the data elements 28 received from the computer infrastructure 11 on an ongoing basis, the host device 25 can readily detect any anomalies associated with the computer environment resources 12.

While various embodiments of the innovation have been particularly shown and described, it will be understood by those skilled in the art that various changes in form and details may be made therein without departing from the spirit and scope of the innovation as defined by the appended claims.

What is claimed is:

1. In a host device, a method for analyzing a set of data elements from a computer infrastructure, comprising:
receiving, by the host device, the set of data elements from the computer infrastructure, the set of data elements relating to at least one attribute of at least one computer environment resource of the computer infrastructure;
assigning, by the host device, each data element of the set of data elements to a data retention location based upon a time statistic identifier associated with each data element of the set of data elements;
comparing, by the host device, a training data set and the data elements associated with a selected data retention location to detect a data anomaly associated with the set of data elements; and
in response to detecting the data anomaly associated with the data elements associated with the selected data retention location, generating, by the host device, a data anomaly notification.

2. The method of claim 1, further comprising, in response to receiving the set of data elements from the computer infrastructure applying, by the host device, a uniformity function the set of data elements to generate a set of normalized data elements, the uniformity function configured to adjust a format associated with the set of data elements.

3. The method of claim 2, further comprising:
in response to assigning each data element of the set of data elements to the data retention location, applying, by the host device, a transformation function to the data elements to generate a transformed set of data elements; and
wherein comparing the training data set and the data elements associated with the selected data retention location comprises comparing, by the host device, the training data set and the transformed set of data elements associated with the selected data retention location to detect a data anomaly associated with the set transformed set of data elements.

4. The method of claim 1, wherein comparing the training data set and the data elements associated with a selected data retention location further comprises applying, by the host device, a rule function to the to the training data set and to the data elements associated with the selected data retention location, the rule function configured to define a subset of data elements of the set of data elements.

5. The method of claim 1, further comprising:
accessing, by the host device, a set of data elements from a selected data retention location to develop the training data set; and
applying, by the host device, a classification function to the set of data elements from the selected data retention location to define the training data set.

6. The method of claim 5, wherein applying the classification function to the to the set of data elements from selected data retention location to define the training data set comprises applying, by the host device, a classification function to the set of data elements from selected data retention location to define the training data set as a set of clusters of the data elements associated with the selected data retention location.

7. The method of claim 1, further comprising:
for a first data retention location, comparing, by the host device, the time statistic identifier associated with each data element with a first retention policy associated with the data retention location; and
when the time statistic identifier of a data element of the data retention location meets the retention policy associated with the data retention location assigning, by the host device, the data element to a second data retention location having a second retention policy, the second retention policy defining a retention time which is greater than a retention time defined by the first retention policy.

8. The method of claim 7, wherein:
accessing the set of data elements from the selected data retention location comprises accessing, by the host device, a stream of data elements in substantially real time from the selected data retention location, the stream of data elements relating to at least one attribute of at least one computer environment resource of the computer infrastructure to develop the training data set in a substantially continuous manner.

9. The method of claim 1, wherein receiving the set of data elements from the computer infrastructure comprises receiving, by the host device, a stream of data elements in substantially real time from the computer infrastructure, the stream of data elements relating to at least one attribute of at least one computer environment resource of the computer infrastructure.

10. A host device, comprising:
a controller having a memory and a processor, the controller configured to:
receive a set of data elements from a computer infrastructure, the set of data elements relating to at least one attribute of at least one computer environment resource of the computer infrastructure;
assign each data element of the set of data elements to a data retention location based upon a time statistic identifier associated with each data element of the set of data elements;
compare a training data set the data elements associated with a selected data retention location to detect a data anomaly associated with the set of data elements; and
in response to detecting the data anomaly associated with the data elements associated with the selected data retention location, generate a data anomaly notification.

11. The host device of claim 10, wherein, in response to receiving the set of data elements from the computer infrastructure, the controller is configured to apply a uniformity function the set of data elements to generate a set of normalized data elements, the uniformity function configured to adjust a format associated with the set of data elements.

12. The host device of claim 11, wherein:
in response to assigning each data element of the set of data elements to the data retention location, the controller is configured to apply a transformation function to the data elements to generate a transformed set of data elements; and
when comparing the training data set and the data elements associated with the selected data retention location, the controller is configured to compare the training data set and the transformed set of data associated with the selected data retention location to detect a data anomaly associated with the set transformed set of data elements.

13. The host device of claim 10, wherein, when comparing the training data set and the data elements associated with a selected data retention location, the controller is configured to apply a rule function to the training data set and to the data elements associated with the selected data retention location, the rule function configured to define a subset of data elements of the set of data elements.

14. The host device of claim 10, wherein the controller is configured to:
access the set of data elements from a selected data retention location to develop the training data set; and
apply a classification function to the set of data elements from the selected data retention location to define the training data set.

15. The host device of claim 14, wherein
wherein applying the classification function to the to the set of data elements from selected data retention location to define the training data set the host device is configured to apply a classification function to the set of data elements from selected data retention location to define the training data set as a set of clusters of the data elements associated with the selected data retention location.

16. The host device of claim 10, wherein the controller is further configured to:
for a first data retention location, compare the time statistic identifier associated with each data element with a first retention policy associated with the data retention location; and
when the time statistic identifier of a data element of the data retention location meets the retention policy associated with the data retention location, assign the data element to a second data retention location having a second retention policy, the second retention policy defining a retention time which is greater than a retention time defined by the first retention policy.

17. The host device of claim 16, wherein:
when accessing the set of data elements from the selected data retention location, the host device is configured to access a stream of data elements in substantially real time from the selected data retention location, the stream of data elements relating to at least one attribute of at least one computer environment resource of the computer infrastructure to develop the training data set in a substantially continuous manner.

18. The host device of claim 10, wherein when receiving the set of data elements from the computer infrastructure the controller is configured to receive a stream of data elements in substantially real time from the computer infrastructure, the stream of data elements relating to at least one attribute of at least one computer environment resource of the computer infrastructure.
